(19) United States
(12) Patent Application Publication
(10) Pub. No.: US 2006/0081823 A1
(43) Pub. Date: Apr. 20, 2006

(54) Ratchet frame

(76) Inventor: Bu Qin Ruan, Zhejiang (CN)

Correspondence Address: Michael Bergman;Bergman Kuta LLP, P.O. Box 400167, Cambridge, MA, 02144, US

(21) Appl. No.: 10/964,984

(22) Filed: Oct. 14, 2004

(51) Int. Cl. B65H 75/44; B25B 25/00

(52) U.S. Cl. 254/218; 242/406

(57) ABSTRACT

The supporter frame for mounting the ratchet can be categorized as mechanical technology, which can be considered a part used in a ratchet assembly. The supporter frame consists of the base, the two supporter plates that are parallel to one another, and attached to the base. At least one slider groove on the base, and the groove is perpendicular to the supporter plates. In addition, there are openings on the supporter plates where the supporter plates attach to the base, with the width of the openings greater than the width of the slider groove. There can be mating guide rails attached to the truck body that will match the size of the slider groove on the supporter plates. When it's time to use the part, all that need to be done is to slide the supporter frame into the guide rails. The supporter frame can be made with aluminum or zinc alloys not only to reduce the weight, but also to simplify the manufacturing process to reduce the cost of manufacturing. The supporter frame provides a convenient way of using the ratchet. The supporter frame can easily be replaced in the event of damage occurring to the supporter frame, or any other components.

### FIELD OF THE INVENTION

The present invention relates to a tie-down, and more particularly to a ratchet tie-down.

### BACKGROUND

During the transportation of goods through automobile, the goods will need to be secured to prevent the goods from falling off the automobile, or crashing into one another to induce damage. It is a common practice to tie the goods down with ropes to the bed of trucks, although it may be a time consuming process that requires a lot of effort, and is difficult to secure the goods properly.

A ratchet is a more advanced tool for tying down the goods. Both Chinese Patent No. 992532027, “Hand operated ratchet” and Chinese Patent No. 011268679, “Semi-Automatic Ratchet” included the frame and belt shaft, and wrap the belt around the shaft. These patents utilize the rotating device on one end of the belt shaft to tighten the belt on the shaft, thus safely and reliably secure the goods.

Currently, it is necessary to secure the frame of the ratchet on the car body. The current method of securing the frame is to weld the frame of the ratchet directly onto the car body. In practical application of the ratchet, it would be a troublesome process to replace the ratchet frame if the frame appears to be broken or damaged. In the meantime, the current material used for making the frame is typically steel, which is very heavy and may result in inconvenience in transportation, storage or usage.

### SUMMARY OF THE INVENTION

The purpose of this new practical invention is to address the problems mentioned above, and to provide a ratchet frame that does not have to be welded onto the car body, and has the characteristics of light-weight and easy operation.

To realize the above purpose, this new practical design adopted the following technical solution: this ratchet frame includes the base and two supporter plates that are fixed on the base and parallel to one another, with the characteristics such as: the aforementioned base will have at least one slider groove that is perpendicular to the supporter plates, and there are openings located on the supporter plates where the slider groove intersects the supporter plates, with the width of the openings greater than that of the slider groove.

There can be guide rails set up on the car body that matches with the slider groove on the base. When using the frame, all that need to be done is to slide the ratchet frame into the guide rail through the slider groove. Due to the fact that the slider groove width is less that of the mating openings, the ratchet frame can only slide within the guide rail instead of falling off of guide rail laterally.

The base in the aforementioned ratchet frame consists of two components: left and right bases, which are securely connected together with the supported plates located on either base.

In the aforementioned ratchet frame, the method to secure the left and right base can be one of the following: welding, bolting or riveting.

Since the base is made of left and right components, thus it is possible to use aluminum or zinc alloy to manufacture the aforementioned ratchet frame through extrusion or die-casting. Not only will this reduce the material weight and thus the weight of the ratchet frame, and bring convenience in transportation, storage and usage, but also simplify the manufacturing process, increase production efficiency to reduce the cost of the product.

Compared to the current technology, the aforementioned new, practical invention of the ratchet frame provides convenience in usage due to simplified sliding the frame into the guide rail instead of welding the frame onto the car body. Then damage occurs to either ratchet frame or other components, it is very easy to replace the damaged component. In the meantime, due to the free sliding of the ratchet frame within the guide rail, the best tie-down effect can be achieved based to how the goods are arranged.

### BRIEF DESCRIPTION OF THE DRAWINGS

FIG. 1 is the main view of the new, practical invention of the ratchet frame;

FIG. 2 is the top view of the new, practical invention of the ratchet frame;

FIG. 3 is the illustration when the ratchet frame is attached to the guide rail; and

FIG. 4 is the main view of the new, practical invention of the ratchet frame attached with a ratchet.

In the figures, 1: base; 11: left base, 12: right base; 13: slider groove; 2: supporter plates; 21: opening(s); 22: positional opening; 3: weld; 4: guide rail; 41: protruded rail; 5: Belt shaft; 6: sprocket.

### DETAILED DESCRIPTION OF THE DRAWINGS

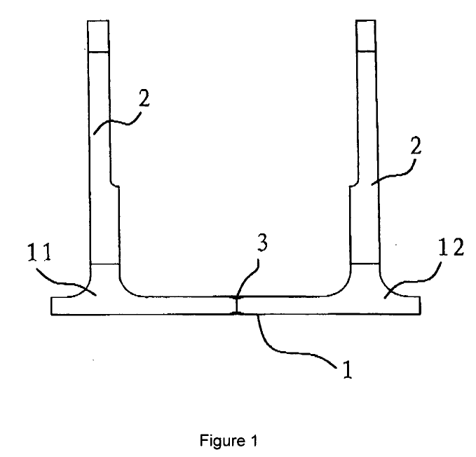

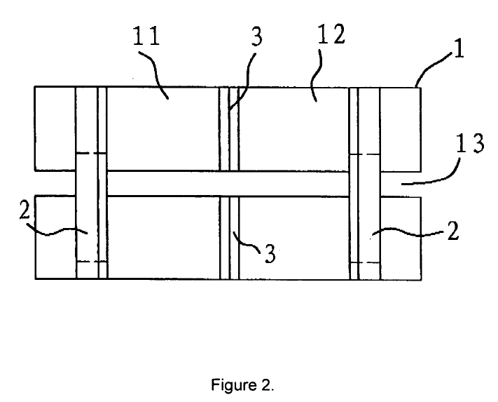

As shown in FIGS. 1 and 2, this new, practical invention of ratchet frame consists of base 1 and supporter plates 2. In this example, base 1 is made of left base 11 and right base 12, with the two bases welded together, and the weld 3 is located in the middle of the two supporter plates 2. Each base 1 is attached with a supporter plate 2, and supporter plates 2 are also attached to base 1. These two supporter plates are parallel to one another.

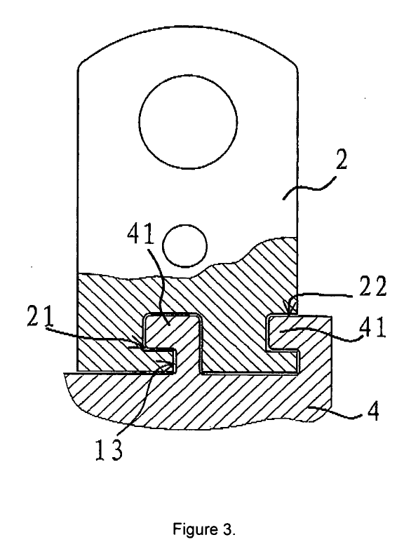

As shown in FIGS. 2 and 3, there is a slider groove 13 on base 1, and the slider groove 13 is perpendicular to supporter plates 2. Each of the supporter plates 2 has an opening 21, which is located at the intersection of slider groove 13 and supporter plates 2. Obviously, the width of the opening 21 is greater than that of the slider groove 13. Guide rail 4 that mates with slider groove 13 is securely located on the car body in application. There is a protruded rail 41 in front of guide rail 4, and the cross-section of the protruded rail 41 will mate with the opening 21. The width of protruded rail 41 is greater than that of the slider groove 13. Thus when sliding the base 1 into guide rail 4 through slider groove 13, the ratchet frame is connected with the car body, and is capable of moving forward and backward, but cannot detach from the rail laterally.

As shown in FIG. 3, in this practical application, there is a positional opening 22 on the side of each of the supporter plates 2. There will also be a protruded rail 41 located on the guide rail that matches with the positional opening 22. This protruded rail 41 will mate with positional opening 22 to provide further stability to ratchet frame on the guide rail 4, and to prevent the frame from vibrating.

In an exemplary embodiment, the whole ratchet frame is made of aluminum alloy through extrusion.

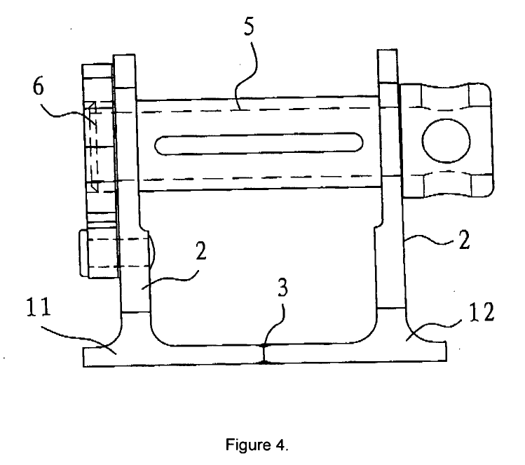

As shown in FIG. 4, when the ratchet is attached to the frame, the belt shaft 5 will go through the two supporter plates 2, and each end of the belt shaft 5 will be the rotating device and sprocket 6. After using the frame, the functionality and the characteristics of the ratchet will all be maintained, with even more advantages. Thus this practical application possesses higher practical value.

1. A supporter frame for a ratchet, including base(1) and two supporter plates(2) that are attached to the base(1), with the two supporter plates parallel to one another, with such the characteristics as: the aforementioned base(1) has at least one opening(13) that is perpendicular to the supporter plates(2), and there will be openings(21) located on the supporter plates where the slider groove(13) and supporter plates(2) are crossed. The openings(21) have width greater than that of the slider groove(13).

2. According to the described patent application 1, the supporter frame has such characteristics as: the base(1) consists of left base(11) and right base(12), which are firmly attached to each other, with each of the two supporter plates(2) located on either base.

3. According to the described patent application 2, the supporter frame has such characteristics as: the aforementioned left base(11) and right base(12) will be firmly attached through welding, bolting or riveting.

4. According to the described patent application 3, the supporter frame has such characteristics as: The aforementioned supporter frame can be made of aluminum or zinc alloy as material, and made through extrusion or die-casting.

5. According to the described patent application 3, the supporter frame has such characteristics as: there will be a positional opening(22) located on each of the supporter plates.
